(19) United States
(12) Patent Application Publication
(10) Pub. No.: US 2023/0386128 A1
(43) Pub. Date: Nov. 30, 2023

(54) IMAGE CLIPPING METHOD AND IMAGE CLIPPING SYSTEM

(71) Applicant: SHANGHAI UNITED IMAGING HEALTHCARE CO., LTD., Shanghai (CN)

(72) Inventors: HAI-TONG ZHAO, Shanghai (CN); XIANG LIU, Shanghai (CN)

(21) Appl. No.: 18/203,106

(22) Filed: May 30, 2023

(30) Foreign Application Priority Data
May 31, 2022 (CN) 202210615787.7

(51) Int. Cl. G06T 15/30; G06V 20/70

(52) U.S. Cl. CPC G06T 15/30; G06V 20/70; G06T 2210/56

(57) ABSTRACT

The present disclosure provides an image clipping method. The method includes obtaining original volume data, labeling a region of interest in the volume data, clipping the original volume data, and generating an image based on the clipped volume data. The labeled region of interest is defined as a non-clipping object such that only volume data other than the region of interest is clipped.

### CROSS-REFERENCE TO RELATED APPLICATIONS

This application claims priority to Chinese Patent Application No. 2022106157873, entitled “IMAGE CLIPPING METHOD AND IMAGE CLIPPING SYSTEM” filed May 31, 2022, the content of which is hereby incorporated by reference in its entirety.

### FIELD

The present disclosure relates to the technical field of medical devices, and particularly to an image clipping method and an image clipping system.

### BACKGROUND

In the medical field, acquiring medical data of a detected subject and performing medical diagnosis based on a corresponding medical image is widely used. When examining the medical image, it is often needed to remove parts of the medical image that are not of interest and to hide the image information outside a clipping surface by a clipping operation. Further, when examining the interior of a medical image, it is also possible to display inside points of interest by the clipping operation such that the internal structure can be observed.

Conventional clipping operations may cancel all image information outside the clipping surface, and only the tissue image inside the clipping box can be displayed. To meet certain application requirements, it's desirable to display the tissue image within a clipping box while also displaying not only the part of the tissue of interest inside the clipping surface but also the part outside of it. However, the realization of this display effect is still a technical difficulty in the field.

### SUMMARY

One aspect of the present disclosure provides an image clipping method, which includes obtaining original volume data, labeling a region of interest in the original volume data, clipping the original volume data, and generating an image based on the clipped volume data. The labeled region of interest is defined as a non-clipping object such that only volume data other than the region of interest is clipped.

In some embodiments, the labeling the region of interest in the original volume data includes assigning a region label to each voxel of volume data of the region of interest.

In some embodiments, the original volume data includes volume data of at least one type of tissue, and the labeling the region of interest in the original volume data includes labeling a tissue of interest in the at least one type of tissue. The labeling the tissue of interest includes assigning a tissue label to each voxel of volume data of the tissue of interest.

In some embodiments, the labeling the region of interest in the original volume data includes labeling the region of interest using a clipping tool.

In some embodiments, the clipping tool includes a clipping box having at least one parallel clipping surface parallel to an outer surface of the original volume data and/or at least one bevel clipping surface intersecting at least three outer surfaces of the original volume data.

In some embodiments, the generating the image based on the clipped volume data includes determining a front surface and a back surface of the clipped volume data based on a configuration of the clipping tool and the region labels of the region of interest and generating a rendered image based on the front surface and the back surface.

In some embodiments, the determining the front surface and the back surface of the clipped volume data includes obtaining the first intersection point of the clipped volume data and each ray projected to the original volume data and defining the front surface based on multiple first intersection points corresponding to multiple rays, and obtaining a last intersection point of the clipped volume data and the each ray projected to the original volume data and defining the back surface based on multiple last intersection points corresponding to the multiple rays.

In some embodiments, the obtaining the first intersection point of the clipped volume data and each ray projected to the clipped volume data includes obtaining an incident point of the ray projected to the original volume data, querying data information in the original volume data from the incident point until the first region label of the region of interest is encountered, and recording a voxel coordinate corresponding to the first region label as the first intersection point corresponding to the ray. The obtaining the first intersection point of the clipped volume data and each ray projected to the clipped volume data further includes defining an intersection point of the ray and a clipping surface of the clipped volume data as the first intersection point corresponding to the ray in response that no region label of the region of interest is encountered while traversing data information between the incident point and the clipping surface.

In some embodiments, the obtaining the first intersection point of the clipped volume data and each ray projected to the clipped volume data includes defining the incident point as the first intersection point corresponding to the ray in response that a surface of the original volume data corresponding to the incident point corresponding to the ray is an unclipping surface.

In some embodiments, the method further includes dividing the original volume data into a plurality of data blocks, and the querying data information in the original volume data from the incident point until the first region label of the region of interest is encountered includes traversing the data blocks of the original volume data from the incident point until the first data block including any of the region labels of the region of interest is encountered and traversing voxels in the first data block including any of the region labels until the first region label of the region of interest is encountered.

In some embodiments, the obtaining the last intersection point of the clipped volume data and each ray projected to the original volume data includes obtaining an exit point of the ray projected to the original volume data, querying data information in the original volume data from the exit point until the first region label of the region of interest is encountered, and recording a voxel coordinate corresponding to the first region label as the last intersection point corresponding to the ray. The obtaining the last intersection point of the clipped volume data and each ray projected to the original volume data further includes defining an intersection point of the ray and a clipping surface of the clipped volume data as the last intersection point of the ray in response that no region label of the region of interest is encountered while traversing data information between the exit point and the clipping surface.

In some embodiments, the obtaining the last intersection point of the clipped volume data and each ray projected to the original volume data includes defining the exit point as the last intersection point corresponding to the ray in response that a surface of the original volume data corresponding to the exit point of the ray is an unclipping surface.

In some embodiments, the method further includes dividing the original volume data into a plurality of data blocks, and the querying data information in the original volume data from the exit point until the first region label of the region of interest is encountered includes traversing the data blocks of the original volume data from the exit point until the first data block including any of the region labels of the region of interest is encountered and traversing voxels in the first data block including any of the region labels until the first region label of the tissue of interest is encountered.

In some embodiments, the generating the rendered image based on the front surface and the back surface includes traversing, along the ray path, voxels on the ray path from the front surface, setting eligible voxels to be visible, and generating the rendered image based on at least one of color information and transparency information of the visible voxels on the ray path.

Another aspect of the present disclosure provides a non-transitory computer readable storage medium storing one or more programs. The one or more programs includes instructions, which when executed by one or more processors, cause the one or more processors to obtain original volume data, label a region of interest in the original volume data, clip the original volume data and generate an image based on the clipped volume data. The labeled region of interest is defined as a non-clipping object such that only volume data other than the region of interest is clipped.

Another aspect of the present disclosure provides a computer system including a memory having instructions stored thereon and a processor. When executing the instructions, the processor is configured to perform an image clipping method which includes obtaining original volume data, labeling a region of interest in the original volume data, clipping the original volume data, and generating an image based on the clipped volume data. The labeled region of interest is defined as a non-clipping object such that only volume data other than the region of interest is clipped.

In some embodiments, the labeling the region of interest in the original volume data includes assigning a region label to each voxel of volume data of the region of interest. The original volume data includes volume data of at least one type of tissue, and the labeling the region of interest in the original volume data includes labeling a tissue of interest in the at least one type of tissue.

In some embodiments, the labeling the region of interest in the original volume data includes labeling the region of interest using a clipping tool. The clipping tool includes a clipping box having at least one parallel clipping surface parallel to an outer surface of the original volume data and/or at least one bevel clipping surface intersecting at least three outer surfaces of the original volume data.

In some embodiments, the generating the image based on the clipped volume data includes determining a front surface and a back surface of the clipped volume data based on a configuration of the clipping tool and the region labels of the region of interest and generating a rendered image based on the front surface and the back surface.

In some embodiments, the determining the front surface and the back surface of the clipped volume data includes obtaining the first intersection point of the clipped volume data and each ray projected to the original volume data, defining the front surface based on multiple first intersection points corresponding to multiple rays, obtaining a last intersection point of the clipped volume data and each ray projected to the original volume data, and defining the back surface based on multiple last intersection points corresponding to multiple rays.

Various other features and advantages of the present disclosure will become more apparent with reference to the following detailed description and the accompanying drawings.

### BRIEF DESCRIPTION OF THE DRAWINGS

FIG. 1 is a schematic flow chart of an image clipping method according to an embodiment of the present disclosure;

FIG. 2 is a schematic diagram showing volume data;

FIG. 3 is a schematic diagram of a clipping box according to an embodiment of the present disclosure;

FIG. 4 is a schematic diagram of a clipping box with a bevel clipping surface according to an embodiment of the present disclosure;

FIG. 5 is a schematic top view showing determination of a front surface and a back surface according to an embodiment of the present disclosure;

FIG. 6 is a schematic side view showing determination of a front surface and a back surface according to an embodiment of the present disclosure;

FIG. 7 is a schematic diagram illustrating a determination of light color based on voxels visible in a ray path according to an embodiment of the present disclosure;

FIG. 8 is a flow chart of generation of an image according to an embodiment of the present disclosure; and

FIG. 9 is a schematic diagram of an image clipping system according to an embodiment of the present disclosure.

### DETAILED DESCRIPTION

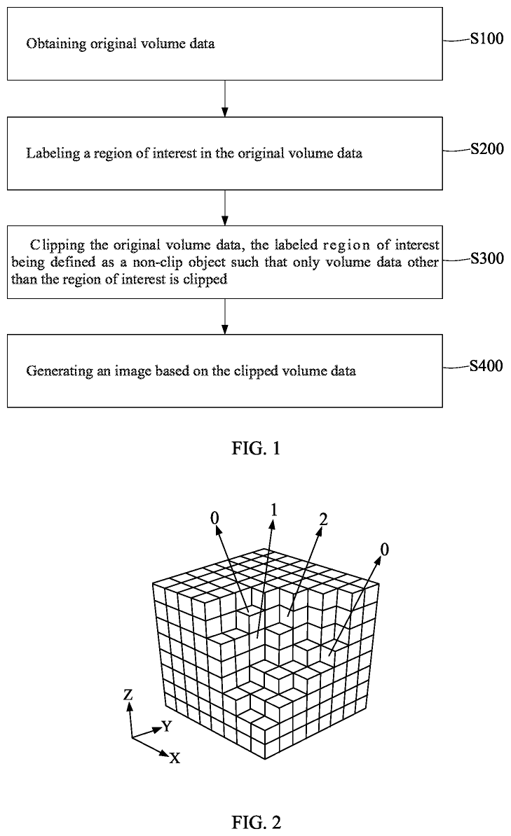

The concept of the present disclosure is to provide an image clipping method and an image clipping system that can selectively clip original volume data so that the clipping operation does not work on a region of interest (e.g., a tissue of interest), and realize that the part of the region of interest outside a clipping surface can still be displayed. Referring to the flow chart of the image clipping method in an embodiment shown in FIG. 1, the image clipping method provided by the present disclosure may include the following steps.

In a step S100, original volume data is obtained.

In a step S200, a region of interest in the original volume data is labeled.

In a step S300, the original volume data is clipped. The labeled region of interest is defined as a non-clipping object such that only volume data other than the region of interest is clipped.

In a step S400, an image is generated based on the clipped volume data.

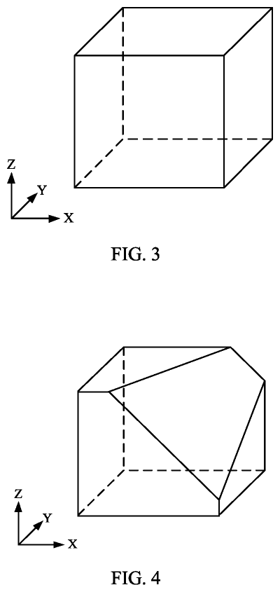

The image clipping method and clipping system provided in the present disclosure may be further described in detail hereinafter with reference to FIGS. 2-9 and specific embodiments. The advantages and features of the present disclosure may become clearer according to the following description. It should be noted that the accompanying drawings are simplified and are not drawn to scale, and they are provided for clearly and readily clarifying the embodiments of the present disclosure only.

In the step S100, original volume data is obtained.

The original volume data may be generated by scanning an object using a scanning device and then performing image reconstruction. The scanning device obtains the original volume data of the object. The scanning device may be, but is not limited to, various imaging devices used in the medical field, such as a computed tomography (CT) device, a magnetic resonance (MR) device, a positron emission computed tomography (PET) device, an ultrasonic imaging device, an X-ray machine, etc.

In some embodiments, the volume data (e.g., as shown with reference to FIG. 2) may include a plurality of voxels in a plurality of dimensions, e.g., in three dimensions. Each voxel has a corresponding voxel value.

In some embodiments, the original volume data includes data information of the at least one type of tissue. The at least one type of tissue in the original volume data may be a tissue constituting a human or animal body, such as a vascular tissue, a bone tissue, or a soft tissue, etc. Alternatively, it may be a sub-tissue within a tissue, such as a bronchus, a lung lobe, a blood vessel, etc. In addition, the original volume data may include at least two types of tissue which may be, for example, a combination of a blood vessel and a bone, or a combination of a blood vessel, a bone, and a soft tissue, etc.

In the step S200, a region of interest in the original volume data is labeled.

In some embodiments, labeling the region of interest in the original volume data includes assigning a region label to each voxel of volume data of the region of interest, so as to realize the labeling of the region of interest.

In some embodiments, the region of interest is defined as a non-clipping object such that subsequent clipping operations may not work on the region of interest. In some embodiments, the non-clipping object may be defined by default or may be defined by the user.

In some embodiments, the original volume data includes volume data of at least one type of tissue, and the region of interest includes a tissue of interest in the at least one type of tissue. In some embodiments, labeling the region of interest in the original volume data includes labeling the tissue of interest in the at least one type of tissue, the region labels include tissue labels, and labeling the tissue of interest includes assigning one tissue label to each voxel of volume data of the tissue of interest. The tissue of interest is thus defined as the non-clipping object in these embodiments.

In some embodiments where the at least one type of tissue includes a single type of tissue, the single type of tissue is the tissue of interest. In some embodiments where the at least one type of tissue includes two types of tissue, one or the two types of tissue may be defined as the tissue of interest such that subsequent clipping operations do not work on the selected tissue. In some embodiments where the at least one type of tissue includes three or more types of tissue, one or more types of tissue may be defined as the tissue of interest such that subsequent clipping operations do not work on the selected one or two types of tissue. In the case of the original volume data including blood vessels and bones, for instance, either the blood vessels or bones, or the both may be selected as the tissue of interest.

It should be understood that the region of interest may include an entire tissue of interest or only a portion of the tissue of interest. For example, in some embodiments, only the diseased portion of the tissue of interest is included in the region of interest.

It should also be understood that there may be one or more regions of interest.

In some embodiments, the labeling of the region of interest (e.g., the tissue of interest) may include extracting the volume data of the region of interest in the original volume data and assigning a region label to each voxel of the region of interest for labeling. In some embodiments, the region of interest can be extracted using a full segmentation algorithm, or a semi-automatic growth algorithm. In some embodiments, it is possible to manually draw a region contour in several axial planes using a VOI (Volume of Interest) tool for multi planner reformation (MPR), and the region can be generated by automatic interpolation. Further, the extracted region can be modified with an eraser tool or clipping tool.

It should be noted that not only the region of interest may be labeled, but also one or more regions other than the region of interest in the original volume data may be labeled. In some embodiments, the original volume data includes one or more types of tissues, and the volume data of one or more types of tissues in the original volume data can be extracted and labeled, which means that not only the data of the tissue of interest can be extracted and labeled, but also the data of other tissues within the original volume data can be extracted and labeled. In some embodiments, the extracted one or more types of tissue can be labeled respectively, i.e., the at least one type of tissue in the original volume data is labeled (e.g., each is assigned a tissue label), and different tissues are assigned different tissue labels. In some embodiments, region labels for voxels of the same region may be the same. In the case of the volume data including blood vessels and bones, for instance, the blood vessels and bones can be assigned different tissue labels for labeling respectively, e.g., tissue label 0 for the blood vessels and tissue label 1 for the bones. In some embodiments, the original volume data may also include non tissue data, such as a bed, which may also be labeled (e.g., label 2 for the bed).

In some embodiments, the region labels for the voxels of the labeled region (e.g., the tissue labels) may be stored in a mask data structure correspondingly. The mask data structure is of the same size as the original volume data. In some embodiments, for example, at least two types of tissue within the original volume data are labeled, and the tissue labels for each voxel of each tissue can then be stored in the mask data structure correspondingly.

It should be recognized that, in some embodiments, one type of tissue in the volume data may be labeled, and the tissue label of the labeled tissue may then be secured to identify the labeled tissue as the tissue of interest. In other embodiments, two or more types of tissue in the original volume data may be labeled, and the corresponding tissue labels may be selectively secured as needed to identify the secured tissue as the tissue of interest. For example, if tissue label 0 is assigned to a blood vessel and tissue label 1 is assigned to a bone, the tissue label of the blood vessel can be secured to identify the blood vessel as the tissue of interest, or the tissue label of the bone can be secured to identify the bone as the tissue of interest.

In the step S300, the original volume data is clipped. The labeled region of interest is defined as a non-clipping object such that only volume data other than the region of interest is clipped.

In some embodiments, the original volume data is clipped using a clipping tool.

The region of interest may be secured during the clipping operation such that the clipping operation does not work on the region of interest and data of the region of interest outside of the clipping surface is retained and can be displayed. The clipping operation may clip the region(s) other than the region of interest in the original volume data.

In some embodiments where the region of interest includes a tissue of interest, the labeled tissue of interest is defined as a non-clipping object such that only volume data other than the tissue of interest is clipped. The tissue of interest may be secured during the clipping operation such that the clipping operation does not work on the tissue of interest and data of the tissue of interest outside of the clipping surface is retained and can be displayed. The clipping operation may clip the tissue(s) other than the tissue of interest in the original volume data. Selective clipping of the different tissues in the original volume data is thus achieved.

As described above, the selected tissue(s) of interest in a specific embodiment can be one type of tissue, two types of tissues, or multiple types of tissues, in which, one or more types of tissue of interest can be secured such that the data of the secured one or more types of tissue will not be clipped. In an exemplary case where the volume data involves blood vessels and bones, when blood vessels are selected as the tissue of interest, the tissue label of blood vessels is secured such that the clipping operation may not work on the data of blood vessels, but may still clip the data of bones to restrict the display range of bones. Conversely, when the bones are selected as the tissue of interest, the tissue label of bones is secured such that the clipping operation may not work on the data of bones, but may still clip the data of blood vessels and restrict the display range of blood vessels. In this way, the relationship between the tissue inside a clipping surface and the tissue of interest can be clearly presented.

It is to be noted that, when describing a region/tissue being inside or outside a clipping surface, it essentially means that the region/tissue is located in a position where regions/tissues therein will be retained or in a position where regions/tissues therein may be clipped off by the clipping surface.

In some embodiments, a clipping box can be set and used as a clipping tool to perform the clipping operation. In this case, the region of interest is defined as the non-clipping object since its region labels are secured, and the data of the region of interest outside the clipping box is retained. In some embodiments, the tissue of interest is defined as the non-clipping object since its tissue labels are secured, and the data of the tissue of interest outside the clipping box is retained.

In some embodiments, the set clipping box has one or more surfaces (also referred to as clipping surfaces), and the clipping surface(s) includes at least one parallel clipping surface parallel to an outer surface(s) of the original volume data. The number and position of the parallel clipping surface(s) can be adjusted according to actual needs. In some embodiments, the coverage of the clipping box can be determined by changing the position of each clipping surface. For example, as shown in FIG. 3, in a specific embodiment, the clipping box is a cube consisting of six parallel clipping surfaces respectively parallel to the outer surfaces of the original volume data. The coverage of the clipping box in the Z direction can be adjusted by adjusting the parallel clipping surface parallel to the XY plane. The coverage of the clipping box in the Y direction can be adjusted by adjusting the parallel clipping surface parallel to the XZ plane. The coverage of the clipping box in the X direction can be adjusted by adjusting the parallel clipping surface parallel to the YZ plane.

In some embodiments, the clipping tool may include at least one bevel clipping surface. For example, as shown in FIG. 4, the clipping tool includes a bevel clipping surface, and the bevel clipping surface intersects at least three outer surfaces of the original volume data. In this case, the orientation and position of the bevel clipping surface, etc. may be adjusted as needed to allow the bevel clipping surface to pass through the region of interest (e.g., the tissue of interest).

In some embodiments, a clipping box with both at least one parallel clipping surface and at least one bevel clipping surface can be used to perform the clipping operation according to the actual needs, i.e., the clipping tool is formed by combining at least one parallel clipping surface parallel to the outer surface(s) of the original volume data and a bevel clipping surface. For example, as shown in FIG. 4, the clipping box is a polyhedron formed by combining a bevel clipping surface with six parallel clipping surfaces respectively parallel to the outer surfaces of the original volume data. In other embodiments, the clipping box may also be foinied by combining two or more bevel clipping surfaces with six parallel clipping surfaces respectively parallel to the outer surfaces of the original volume data. In sum, the clipping surfaces of the clipping box (including the parallel clipping surfaces respectively parallel to the outer surfaces of the original volume data and the bevel clipping surface) can be adjusted in direction and/or in number.

It should be understood that the above descriptions are for illustration purpose. In some embodiments, the clipping the original volume data may be achieved via a computer instruction.

In some embodiments, after performing the clipping operation, the method further includes storing the equation of each clipping surface to be used for implementing a rendering process. For example, the equation of a clipping surface in the coordinate system of the volume data can be obtained based on a point within the clipping surface and the direction of a normal vector of the clipping surface.

In the step S400, an image is generated based on the clipped volume data.

With reference to FIG. 8, in some embodiments, the method of generating the image may include determining a front surface and a back surface of the clipped volume data and generating a rendered image based on the front surface and the back surface. The front and back surfaces of the clipped volume data are dependent on the configuration of the clipping tool and the region labels of the region of interest (e.g., the tissue labels of the tissue of interest). The configuration of the clipping tool includes but not limited to position, orientation, and/or structure of the clipping tool.

In some embodiments, a surface with a predetermined orientation may be defined as the front surface and a surface with an orientation opposite to the predetermined orientation may be defined as the back surface. In FIG. 4, for example, the surface corresponding to the bevel clipping surface may be defined as the front surface and the surface opposite to the bevel clipping surface may be defined as the back surface. In some alternative embodiments, the surface facing the observation direction (sight direction) may be defined as the front surface and the surface opposite to the observation direction (sight direction) may be defined as the back surface.

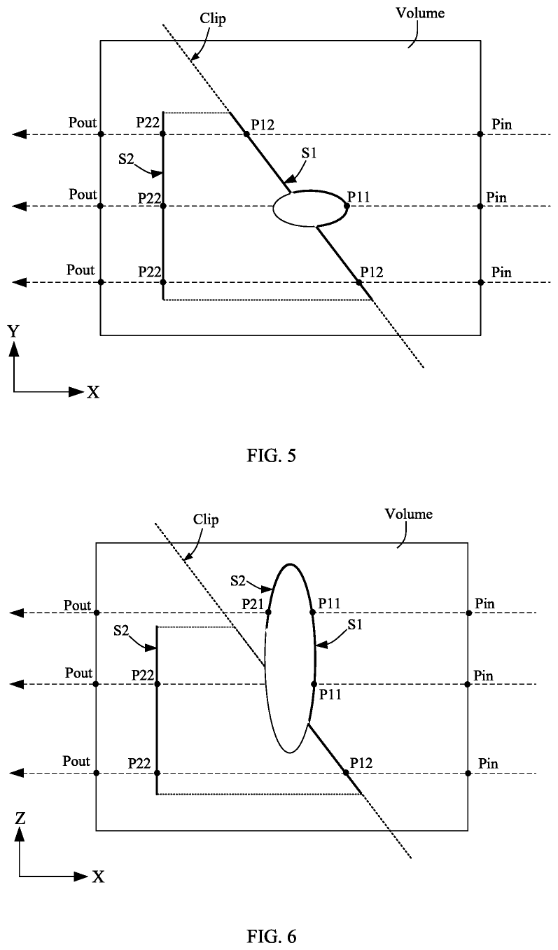

Further, referring to FIGS. 5-6, the method for determining the front and back surfaces of the clipped volume data can include determining the first intersection points and last intersection points based on the configuration of the clipping tool and the region labels of the region of interest (e.g., the tissue label of the tissue of interest). For example, the first intersection point of the clipped volume data and each ray projected to the original volume data is obtained, and the front surface is defined by multiple first intersection points corresponding to multiple rays. The last intersection point of the clipped volume data and each ray projected to the original volume data is obtained, and the back surface is defined by multiple last intersection points corresponding to the multiple rays.

It is to be noted that, FIG. 5 is, for example, a top view of a structure of the volume data viewed from bottom to top, and FIG. 6 is, for example, a side view of the volume data, with the XY plane, for example, parallel to the horizontal plane, and with the Z direction corresponding to the vertical direction. Exemplarily, the elliptical sections in FIGS. 5-6 represent the region of interest (e.g., the tissue of interest), and the elliptical region of interest shown in the figures is only an example for ease of understanding.

With continued reference to FIGS. 5-6, the method of obtaining the first intersection point of each ray and the clipped volume data includes obtaining the incident point (Pin) of each ray projected to the original volume data, querying the data information in the volume data from the incident point (Pin) until the first region label of the region of interest is encountered, and recording the voxel coordinate corresponding to first region label as a coordinate of the first intersection point (P11) corresponding to the ray. If no region label of the region of interest is encountered while traversing the data information between the incident point (Pin) and an intersection point of the ray and the clipping surface (e.g., the clipping surface of the clipped volume data closest to the incident point (Pin)), the intersection point of the ray and the clipping surface (e.g., the bevel clipping surface (Clip)) is defined as the first intersection point (e.g., the first intersection point (P12) falling on the clipping surface shown in FIGS. 5-6). In this way, the front surface (S1) of the clipped volume data can be defined based on multiple first intersection points corresponding to multiple rays. It should be understood that clipping surfaces of the clipped volume data overlap corresponding clipping surfaces of the clipping tool, respectively.

It should be understood that in the embodiments where the region of interest includes a tissue of interest is labeled, the first region label of the region of interest is just the first tissue label of the tissue of interest (exemplarily represented by the elliptical portion in FIGS. 5-6).

It should also be noted that, in FIGS. 5-6, the front surface includes a surface of the original volume data that was clipped when the original volume data was clipped, which is described for illustration purpose. However, in some alternative embodiments, the front surface may be a surface of the original volume data that was not clipped when the original volume data was clipped. In this case, the surface corresponding to the incident points (Pin) of the rays projected to the original volume data Volume is an unclipping surface, and the incident points (Pin) can be defined as the first intersection points of the rays.

The method of obtaining the last intersection point of each ray and the clipped volume data includes obtaining an exit point (Pout) of each ray projected to the original volume data, querying the data information in the volume data from the exit point (Pout) until the first region label of the region of interest is encountered, and recording the voxel coordinate corresponding to the first region label as a coordinate of the last intersection point corresponding to the ray (e.g., the last intersection point (P21) falling on the region of interest shown in FIG. 6). If no region label of the region of interest is encountered while traversing the data information between the exit point (Pout) and an intersection point of the ray and the clipping surface (e.g., the clipping surface of the clipped volume data closest to exit point (Pout)), then the intersection point of the ray and the clipping surface is defined as the last intersection point (e.g., the last intersection point P22 falling on the clipping surface shown in FIGS. 5-6). In this way, the back surface S2 of the clipped volume data can be defined based on multiple last intersection points corresponding to multiple rays.

It should also be noted that, in FIGS. 5-6, the back surface includes a surface of the original volume data that was clipped when the original volume data was clipped, which is described for illustration purpose. However, in some alternative embodiments, the back surface may be a surface of the original volume data that was not clipped when the original volume data was clipped. In this case, the surface of the original volume data corresponding to the exit points (Pout) of the rays projected to the original volume data (Volume) is an unclipping surface, and the exit points (Pout) can be defined as the last intersection points corresponding to the rays.

In some embodiments, the volume data and a screen are located in a three-dimensional space with a certain distance therebetween, and from a perspective of a viewer, the rays in parallel are projected from the screen to the volume data.

In a further embodiment, the original volume data may be divided into a plurality of data blocks. In exemplary embodiments, the original volume data is divided into n k data blocks, where n, m, and k represent the edge lengths of the data blocks which are measured in voxels. The values of n, m, and k may be the same or different. For example, each edge length of the divided block corresponds to the same number of voxels. Based on this, when querying the data information from the incident point (Pin), the data blocks of the volume data are traversed until the first data block including any of the region labels of the region of interest is encountered, and the first data block is recorded. Then, the voxels in the first data block are traversed until the first region label of the region of interest is encountered, and the first intersection point of the corresponding ray and the clipped volume data is thus obtained. Similarly, when querying the data information from the exit point (Pout), the data blocks of the volume data are traversed until the first data block including any of the region labels of the region of interest is encountered, and the first data block is recorded. Then, the voxels in the first data block are traversed until the first region label of the region of interest is encountered, and the last intersection point (P2) of the corresponding ray and the clipped volume data is thus obtained.

In some embodiments, by dividing the volume data into a plurality of data blocks, it is possible to perform identification and queries in data blocks, which improves the efficiency of identification of region labels (e.g., tissue labels) in the volume data, and effectively reduces the amount of data processing.

Despite that rays are introduced in the determination of the front and back surfaces of the clipped volume data as described above, it is to be understood that in some embodiments, the rays are virtual and are only provided to indicate the direction in which the data information in the volume data is queried.

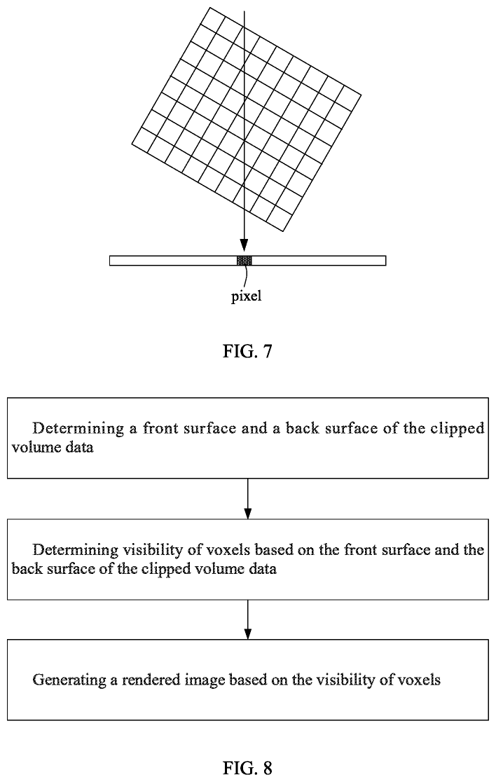

Upon determination of the front and back surfaces of the clipped volume data, a rendering operation can be performed to generate a rendered image, specifically based on a ray casting algorithm or a ray tracing algorithm. Referring to FIGS. 7-8, the method of performing rendering includes determining visibility of voxels based on the front surface and the back surface and generating a rendered image based on the visibility of voxels. In some embodiments, voxels on a path of the ray (also referred to as a ray path) are traversed from the front surface and eligible voxels are set to be visible. A color of the ray (e.g., a light ray) may be determined based on color information and transparency information of the visible voxels on the ray path. A rendered image showing both the region inside the clipping surface and the region of interest is finally obtained. In some embodiments, the voxels that are set to be visible each have a weight in the corresponding ray, and are thus able to be used for image rendering. The eligible voxels that are set to be visible can be, in particular, voxels that are located inside the clipping surface or voxels of the region of interest, which belong to the region that needs to be displayed. If the region to which these voxels belong needs to be displayed, these voxels are set as eligible voxels. In some embodiments, the color information and the transparency information can be determined based on one or more transfer function parameters. The transfer function parameter(s) contain a mapping between color and transparency values and grayscale values. The color information and transparency information can be found based on the grayscale values of the voxels during rendering.

In some embodiments, the voxels can be judged one by one to determine whether the voxel belongs to a region that needs to be displayed (e.g., the region of interest), and to further determine the visibility of the voxel. By judging voxels one by one, it can be ensured that each ray may not be mixed with the color of voxels that do not need to be displayed in the rendering process, and the correctness of the image rendering result can be effectively guaranteed. In some embodiments, the original volume data is divided into data blocks, such that the data blocks on the ray path can be traversed from the front surface to determine the visibility of the data blocks one by one, and the visibility of voxels of the data block including visible voxels can be then determined one by one.

Upon determination of the visible voxels, the ray color can be calculated based on the visible voxels on the ray path. The calculation of ray color may include collecting, along the ray path, the color information and transparency information of the visible voxels on the ray path, cumulating the color information and transparency information of the visible voxels to obtain the color of the corresponding pixel, and then generating the color of the rendered image. In some embodiments, a Monte Carlo-based ray tracing algorithm is used to determine ray sampling point by distance sampling. The color information and transparency information of the voxels is determined by a bi-directional reflectance distribution function (BRDF) or phase function based on the gradient values at the sampling points, and finally, the color of the pixels corresponding to that ray in the final rendered image is obtained by weighting.

In some embodiments, after performing the clipping operation, the method further includes performing an interaction operation such as rotation of the clipped image data, and performing step S400 to refresh each frame of the image after each interaction operation such as rotation.

From the above description of the clipping of the volume data and image rendering, it is understood that the data clipping described in the present disclosure is directed to a virtual action based on software instructions) for processing voxels of volume data, including but not limited to, for example, local data removal, local data hiding, etc., for the purpose of the subsequent image rendering based on only those voxels that need to be retained.

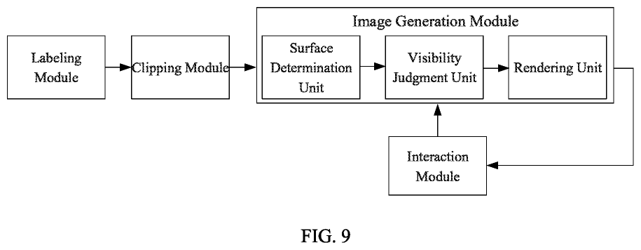

The present disclosure also provides an image clipping system. Referring to FIG. 9, the image clipping system includes a labeling module, a clipping module, and an image generation module.

The labeling module is configured to label the region of interest in the volume data by assigning tissue labels to define the region of interest as a none clipping object.

The clipping module is configured to clip the volume data other than the labeled region of interest. In specific embodiments, the clipping module may set a clipping box and/or bevel clipping surface to perform a clipping operation on the volume data and secure the region labels of the region of interest such that the clipping operation does not work on the region of interest, but only on the volume data other than the region of interest.

Further, the image generation module is configured to generate an image based on the clipped volume data. As such, the image generated by the image generation module can show the region inside the clipping surface and the region of interest outside the clipping surface, clearly expressing the relationship between the region inside the clipping surface and the region of interest.

Further, the image generation module includes a surface determination unit configured to determine a front surface and a back surface of the clipped volume data based on the clipping position and the region labels of the region of interest. In some embodiments, the surface determination unit includes an intersection point obtaining subunit and a surface obtaining subunit. The intersection point obtaining subunit is configured to obtain the first intersection point and the last intersection point (P2) of each ray and the clipped volume data. The surface obtaining subunit is configured to determine the front surface based on multiple first intersection points corresponding to multiple rays and to determine the back surface based on multiple last intersection points corresponding to multiple rays.

In some embodiments, obtaining the first intersection point (P1) of each ray and the clipped volume data by the intersection point obtaining subunit includes obtaining the incident point (Pin) of each ray projected to the original volume data, and querying the data information in the volume data from the incident point (Pin) until the first region label of the region of interest is encountered. The first intersection point corresponding to the ray is thus obtained. If no region label of the region of interest is encountered while traversing the data information between the incident point (Pin) and the intersection point of the ray and the clipping surface, the intersection point of the ray and the clipping surface (e.g., the bevel clipping surface Clip) is defined as the first intersection point. In this way, the intersection point obtaining subunit is able to define the front surface S1 of the clipped volume data based on multiple first intersection points corresponding to multiple rays.

Similarly, obtaining the last intersection point (P2) of each ray and the clipped volume data by the intersection point obtaining subunit includes obtaining the exit point (Pout) of each ray projected to the original volume data, and querying the data information in the volume data from the exit point (Pout) until the first region label of the region of interest is encountered. The last intersection point of the ray is thus obtained. If no region label of the region of interest is encountered while traversing the data information between the exit point (Pout) and the intersection point of the ray and the clipping surface, the intersection point of the ray and the clipping surface is defined as the last intersection point P2. In this way, the intersection point obtaining subunit is able to define the back surface S2 of the clipped volume data based on multiple last intersection points corresponding to multiple rays.

With continued reference to FIG. 9, the image generation module further includes a visibility judgment unit configured to traverse the voxels on the ray path from the front surface to determine whether the voxels on the ray path need to be displayed and configured to set the voxels needing to be displayed as visible. Further, the visibility judgment unit may be configured to determine whether the voxels inside the clipping surface need to be displayed and to determine whether voxels of the region of interest need to be displayed. A rendering unit may calculate the color of the rays based on at least one of the color information and the transparency information of the voxels visible on the ray path, and thereby generate a rendered image.

In some embodiments, the image clipping system further includes an interaction module for performing an interaction operation such as rotation of the clipped image data. In some embodiments, the image generation module is configured to refresh each image frame after each interactive operation such as rotation is performed.

In summary, according to the image clipping method provided in various embodiments, the region of interest is labeled so that the clipping operation does not work on the region of interest such that the data information of the region of interest outside the clipping surface is retained when the clipping operation is performed. As such, the valid image outside the clipping surface is retained. In addition, the clipping operation still clips the regions other than the region of interest in the volume data, so that selective clipping operation on different regions in the volume data is achieved. The generated image can thus clearly express the relationship between the region inside the clipping surface and the region of interest by showing the region inside the clipping surface and the region of interest outside the clipping surface.

The present disclosure also provides a computer system. The computer system includes a memory having instructions stored therein and a processor. The processor, when executing the instructions, performs the image clipping method as described in the above embodiments.

The present disclosure also provides a non-transitory computer readable storage medium in which one or more programs are stored. The one or more programs include instructions. The instructions, when executed by the one or more processors, the one or more processors performing the image clipping method as described in the above embodiments.

It is noted that although the present disclosure has been disclosed as above in preferred embodiments, the above embodiments are not intended to limit the present disclosure. For any person skilled in the art, many possible variations and modifications to the technical solution of the present disclosure can be made using the technical content disclosed above, or modified to equivalent embodiments with equivalent variations, without departing from the scope of the technical solution of the present disclosure. Therefore, any simple modifications, equivalent changes, and modifications made to the above embodiments based on the technical substance of the present disclosure, without departing from the content of the technical solution of the present disclosure, still fall within the scope of protection of the technical solution of the present disclosure.

It should also be understood that, unless otherwise specified or indicated, the terms “first”, “second”, “third”, etc. used in the specification are merely used to distinguish between various components, elements, steps, etc. described in the specification, and are not used to indicate any logical or sequential relationship between the components, elements, steps, etc. Furthermore, it should be recognized that the singular forms “a” and “one” used herein and in the appended claims include plural referents unless the context clearly dictates otherwise. For example, references to “a step” or “a device” may mean one or more steps or devices, and may include subsidiary steps and subsidiary devices. All conjunctions used are to be understood in their broadest possible sense. Additionally, the word “or” is to be understood to have the definition of a logical “or” unless the context clearly indicates otherwise. Moreover, the implementation of the methods and/or devices in the embodiments of the present invention may be performed manually, automatically, or in combination, to accomplish the selected task.

What is claimed is:

1. An image clipping method, comprising:
obtaining original volume data;
labeling a region of interest in the original volume data;
clipping the original volume data, the labeled region of interest being defined as a non-clipping object such that only volume data other than the region of interest is clipped; and
generating an image based on the clipped volume data.

2. The image clipping method of claim 1, wherein the labeling the region of interest in the original volume data comprises assigning a region label to each voxel of volume data of the region of interest.

3. The image clipping method of claim 2, wherein the original volume data includes volume data of at least one type of tissue, the labeling the region of interest in the original volume data comprising
labeling a tissue of interest in the at least one type of tissue, the labeling the tissue of interest comprising
assigning a tissue label to each voxel of volume data of the tissue of interest.

4. The image clipping method of claim 2, wherein the labeling the region of interest in the original volume data comprises labeling the region of interest using a clipping tool.

5. The image clipping method of claim 4, wherein the clipping tool includes a clipping box having at least one parallel clipping surface parallel to an outer surface of the original volume data or at least one bevel clipping surface intersecting at least three outer surfaces of the original volume data.

6. The image clipping method of claim 4, wherein the generating the image based on the clipped volume data comprises:
determining a front surface and a back surface of the clipped volume data based on a configuration of the clipping tool and the region labels of the region of interest; and
generating a rendered image based on the front surface and the back surface.

7. The image clipping method of claim 6, wherein the determining the front surface and the back surface of the clipped volume data comprises:
obtaining the first intersection point of the clipped volume data and each ray projected to the original volume data and defining the front surface based on multiple first intersection points corresponding to multiple rays; and
obtaining the last intersection point of the clipped volume data and the each ray projected to the original volume data and defining the back surface based on multiple last intersection points corresponding to the multiple rays.

8. The image clipping method of claim 7, wherein the obtaining the first intersection point of the clipped volume data and each ray projected to the clipped volume data comprises:
obtaining an incident point of the ray projected to the original volume data, querying data information in the original volume data from the incident point until the first region label of the region of interest is encountered, and recording a voxel coordinate corresponding to the first region label as a coordinate of the first intersection point corresponding to the ray; and
defining an intersection point of the ray and a clipping surface of the clipped volume data as the first intersection point corresponding to the ray in response that no region label of the region of interest is encountered while traversing data information between the incident point and the intersection point of the clipping surface.

9. The image clipping method of claim 8, wherein obtaining the first intersection point of the clipped volume data and each ray projected to the clipped volume data comprises:
defining the incident point as the first intersection point corresponding to the ray in response that a surface of the original volume data corresponding to the incident point is an unclipping surface.

10. The image clipping method of claim 8, further comprising dividing the original volume data into a plurality of data blocks,
wherein the querying data information in the original volume data from the incident point until the first region label of the region of interest is encountered comprises:
traversing the data blocks of the original volume data from the incident point until the first data block comprising any of the region labels of the region of interest is encountered; and
traversing voxels in the first data block comprising any of the region labels until the first region label of the region of interest is encountered.

11. The image clipping method of claim 7, wherein the obtaining the last intersection point of the clipped volume data and each ray projected to the original volume data comprises:
obtaining an exit point of the ray projected to the original volume data, querying data information in the original volume data from the exit point until the first region label of the region of interest is encountered, and recording a voxel coordinate corresponding to the first region label as a coordinate of the last intersection point corresponding to the ray; and
defining an intersection point of the ray and a clipping surface of the clipped volume data as the last intersection point corresponding to the ray in response that no region label of the region of interest is encountered while traversing data information between the exit point and the intersection point of the clipping surface.

12. The image clipping method of claim 11, wherein the obtaining the last intersection point of the clipped volume data and each ray projected to the original volume data comprises:
defining the exit point as the last intersection point corresponding to the ray in response that a surface of the original volume data corresponding to the exit point of the ray is an unclipping surface.

13. The image clipping method of claim 11, further comprising dividing the original volume data into a plurality of data blocks,
wherein the querying data information in the original volume data from the exit point until the first region label of the region of interest is encountered comprises:
traversing the data blocks of the original volume data from the exit point until the first data block comprising any of the region labels of the region of interest is encountered; and
traversing voxels in the first data block comprising any of the region labels until the first region label of the tissue of interest is encountered.

14. The image clipping method of claim 6, wherein the generating the rendered image based on the front surface and the back surface comprises:
traversing, along a ray path, voxels on the ray path from the front surface, and setting eligible voxels to be visible; and
generating the rendered image based on at least one of color information and transparency information of the visible voxels on the ray path.

15. A non-transitory computer readable storage medium storing one or more programs, the one or more programs comprising instructions, which when executed by one or more processors, cause the one or more processors to:
obtain original volume data;
label a region of interest in the original volume data;
clip the original volume data, the labeled region of interest being defined as a non-clipping object such that only volume data other than the region of interest is clipped; and
generate an image based on the clipped volume data.

16. A computer system comprising a memory having instructions stored thereon and a processor, wherein when executing the instructions, the processor is configured to perform an image clipping method, the method comprising:
obtaining original volume data;
labeling a region of interest in the original volume data;
clipping the original volume data, the labeled region of interest being defined as a non-clipping object such that only volume data other than the region of interest is clipped; and
generating an image based on the clipped volume data.

17. The computer system of claim 16, wherein the labeling the region of interest in the original volume data comprises assigning a region label to each voxel of volume data of the region of interest.

18. The computer system of claim 17, wherein the labeling the region of interest in the original volume data comprises labeling the region of interest using a clipping tool, and the clipping tool includes a clipping box having at least one parallel clipping surface parallel to an outer surface of the original volume data or at least one bevel clipping surface intersecting at least three outer surfaces of the original volume data.

19. The computer system of claim 18, wherein the generating the image based on the clipped volume data comprises:
determining a front surface and a back surface of the clipped volume data based on a configuration of the clipping tool and the region labels of the region of interest; and
generating a rendered image based on the front surface and the back surface.

20. The computer system of claim 19, wherein the determining the front surface and the back surface of the clipped volume data comprises:
obtaining the first intersection point of the clipped volume data and each ray projected to the original volume data and defining the front surface based on multiple first intersection points corresponding to multiple rays; and
obtaining the last intersection point of the clipped volume data and the each ray projected to the original volume data and defining the back surface based on multiple last intersection points corresponding to the multiple rays.
